(19) United States
(12) Patent Application Publication
(10) Pub. No.: US 2018/0351205 A1
(43) Pub. Date: Dec. 6, 2018

(54) ALL-SOLID-STATE BATTERY AND METHOD OF MANUFACTURING THE SAME

(71) Applicants: HYUNDAI MOTOR COMPANY, Seoul (KR); KIA MOTORS CORPORATION, Seoul (KR)

(72) Inventors: Oh Min KWON, Nam-gu (KR); Yong Sub YOON, Seoul (KR); Kyung Su KIM, Yongin-si (KR); Hong Seok MIN, Yongin-si (KR)

(21) Appl. No.: 15/824,673

(22) Filed: Nov. 28, 2017

(30) Foreign Application Priority Data
Jun. 1, 2017 (KR) 10-2017-0068284

(51) Int. Cl. H01M 10/0525; H01M 10/0562; H01M 10/058

(52) U.S. Cl. CPC H01M 10/0525; H01M 2300/0068; H01M 10/058; H01M 10/0562

(57) ABSTRACT

Disclosed are an all-solid-state battery and a method of manufacturing the same, in which lithium ions that are consumed in an initial side reaction are supplemented by artificially increasing the amount of added lithium salt during an electrode manufacturing process, and an interface between electrodes is stabilized. The all-solid-state battery includes a cathode active material; an anode active material; and a solid electrolyte, wherein the amount of the solid electrolyte is determined by the sum of a target amount of the solid electrolyte, the target amount being set corresponding to the amounts of the cathode active material and the anode active material, and an additional amount of the solid electrolyte, wherein the additional amount of the solid electrolyte is equal to or less than 1.5 parts by weight (excluding 0 parts by weight) based on 100 parts by weight of the target amount of the solid electrolyte.

### CROSS REFERENCE TO RELATED APPLICATION

The present application claims priority to Korean Patent Application No. 10-2017-0068284, filed Jun. 1, 2017, the entire contents of which is incorporated herein for all purposes by this reference.

### BACKGROUND OF THE INVENTION

### Field of the Invention

The present invention relates generally to an all-solid-state battery and a method of manufacturing the same. More particularly, the present invention relates to an all-solid-state battery and a method of manufacturing the same, in which lithium ions that are consumed in an initial side reaction are supplemented by artificially increasing the amount of added lithium salt during an electrode manufacturing process, and an interface between electrodes is stabilized.

### Description of the Related Art

As well known in the art, lithium secondary batteries are used as power sources for a variety of electronic devices ranging from mobile phones, notebooks, and small household appliances to automobiles and high-capacity power storage devices, and their demand is also increasing. As a result, the required performance of a lithium secondary battery is also increasing, and studies related thereto have been actively conducted.

At present, a liquid electrolyte containing an organic substance is mainly used as an electrolyte of a lithium secondary battery. Such a liquid electrolyte has an advantage of high lithium ion conductivity. However, electrolyte leakage may occur, and there is a risk of ignition and explosion at high temperatures, so safety improvements are required.

Due to this safety problem, an all-solid-state battery employing a solid electrolyte has recently been developed and used.

FIG. 1 is a schematic view showing a configuration of a general all-solid-state battery. The all-solid-state battery largely includes a cathode layer 10, a solid electrolyte layer 20, and an anode layer 30.

The cathode layer 10 includes a cathode active material 11 and a solid electrolyte 13, and may further include a conductive material (not shown) and a binder (not shown).

The solid electrolyte layer 20 may further include a polymer (not shown) in addition to the solid electrolyte 21.

The anode layer 30 includes an anode active material 31 and a solid electrolyte 33 similarly to the cathode layer 10, and may further include a conductive material and a binder.

This all-solid-state battery is a battery system that replaces an organic electrolyte of a commercial lithium secondary battery with a solid electrolyte, the battery system capable of realizing high energy and high output density as well as high safety by using highly conductive and flame retardant materials.

Unlike liquid batteries, the all-solid-state battery employs the solid electrolyte, which acts as a separator as well as an electrolyte. In addition, compact packaging is provided by fabricating high-voltage cells through bipolar stacking, thereby implementing a more compact battery system than a general lithium-ion battery.

However, the all-solid-state battery is problematic in that mobile lithium ions to be involved in the reversible reaction are consumed in the electrochemical side reaction during the initial charging and initial discharging process, and the number of effective lithium ions is rapidly reduced from a first discharge, thereby reducing energy of the electrodes.

The foregoing is intended merely to aid in the understanding of the background of the present invention, and is not intended to mean that the present invention falls within the purview of the related art that is already known to those skilled in the art.

### SUMMARY OF THE INVENTION

Accordingly, the present invention has been made keeping in mind the above problems occurring in the related art, and the present invention is to propose an all-solid-state battery and a method of manufacturing the same, in which lithium ions that are consumed in an initial side reaction are supplemented by artificially increasing the amount of added lithium salt during an electrode manufacturing process, and an interface between electrodes is stabilized.

In order to achieve the above object, according to one aspect of the present invention, there is provided an all-solid-state battery, including a cathode active material; an anode active material; and a solid electrolyte, wherein the amount of the solid electrolyte is determined by the sum of a target amount of the solid electrolyte, the target amount being set corresponding to the amounts of the cathode active material and the anode active material, and an additional amount of the solid electrolyte, wherein the additional amount of the solid electrolyte is equal to or less than 1.5 parts by weight (excluding 0 parts by weight) based on 100 parts by weight of the target amount of the solid electrolyte.

The solid electrolyte may be lithium salt.

The solid electrolyte may be LiFSI or LiPF6.

The additional amount of the solid electrolyte may be 0.1 to 1.0 parts by weight based on 100 parts by weight of the target amount of the solid electrolyte.

According to another aspect of the present invention, there is provided a method of manufacturing an all-solid-state battery, wherein the all-solid-state battery includes a cathode active material, an anode active material, and a solid electrolyte, the method including: preparing a cathode active material, an anode active material, and a solid electrolyte; setting a target amount of the solid electrolyte corresponding to the amounts of the cathode active material and the anode active material; determining an actual amount of the solid electrolyte by adding an additional amount of the solid electrolyte set to equal to or less than 1.5 parts by weight (excluding 0 parts by weight) based on 100 parts by weight of the target amount of the solid electrolyte to the target amount of the solid electrolyte; and forming a battery by applying the actual amount of the solid electrolyte.

The solid electrolyte may be lithium salt.

The solid electrolyte may be LiFSI or LiPF6.

The additional amount of the solid electrolyte may be 0.1 to 1.0 parts by weight based on 100 parts by weight of the target amount of the solid electrolyte.

According to the embodiments of the present invention, the amount of lithium salt is artificially increased during the electrode manufacturing process to replenish lithium ions that are consumed in the initial side reaction, so that the number of mobile lithium ions can be increased, and the activation energy of lithium ions is reduced due to formation of a low-resistance interface between electrolyte and electrodes, so that the effect of enhancing output characteristics of the battery can be expected.

Further, the further added lithium salt can fill pores formed between the solid electrolyte and the active materials so that paths for lithium-ion transfer are increased, thereby enhancing output characteristics of the battery.

Further, the further added lithium salt compensates for lithium ions consumed in the side reaction occurring during a first charge/discharge process, thereby increasing energy density of the battery.

Further, lithium salt that forms a stable solid electrolyte interphase (SEI) is further added to form a stable cathode/electrolyte interface through the initial electrochemical reaction, thereby improving lifespan characteristics of the battery.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a schematic view showing a configuration of a general all-solid-state battery; and

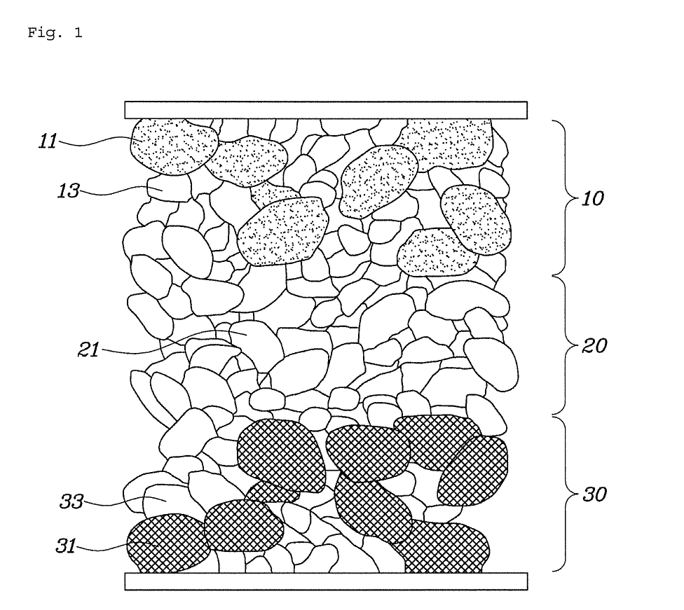

FIG. 2 is a comparison graph showing initial efficiency and initial capacity of Comparative Examples and Examples.

### DETAILED DESCRIPTION OF THE INVENTION

Hereinbelow, exemplary embodiments of the present invention will be described in detail with reference to the accompanying drawings. Embodiments of the present invention are presented to make complete disclosure of the present invention and help those who are ordinarily skilled in the art best understand the invention. Various changes to the following embodiments are possible and the scope of the present invention is not limited to the following embodiments.

An all-solid-state battery according to an embodiment of the present invention is an all-solid-state battery including a cathode active material, an anode active material, and a solid electrolyte.

Herein, the amounts of the cathode active material, the anode active material, and the solid electrolyte are determined by the capacity of the all-solid-state battery. In general, the amount of the solid electrolyte is set corresponding to the amounts of the cathode active material and the anode active material.

However, in the all-solid-state battery according to the embodiment of the present invention, the amount of the solid electrolyte is determined by the sum of a target amount of the solid electrolyte, which is set corresponding to the amounts of the cathode active material and the anode active material, and an additional amount of the solid electrolyte. Here, the addition of the solid electrolyte is performed to compensate for lithium ions that are consumed in an initial side reaction of the battery, so that the additional amount of the solid electrolyte may be determined relative to the target amount thereof.

Thus, the additional amount of the solid electrolyte may be equal to or less than 1.5 parts by weight (excluding 0 parts by weight) based on 100 parts by weight of the target amount of the solid electrolyte. As a result, initial discharge efficiency is maintained at equal to or greater than 75%, and initial discharge capacity is maintained at equal to or greater than 125 mAh/g. When more than the target amount of the solid electrolyte is added, initial efficiency and initial capacity are improved because it replenishes the lithium ions that are consumed in the side reaction occurring during the initial discharge. However, initial efficiency and initial capacity are not continuously improved as the additional amount of the solid electrolyte increases, but initial efficiency and initial capacity are lowered based on when 0.5 parts by weight of the appropriate amount of the solid electrolyte is further added. Accordingly, when the additional amount of the solid electrolyte exceeds 1.5 parts by weight, initial efficiency and initial capacity tend to be similar to or less than the state in which the solid electrolyte is not added relative to the target amount. Thus, the additional amount of the solid electrolyte may be maintained at equal to or less than 1.5 parts by weight (excluding 0 parts by weight) based on 100 parts by weight of the target amount of the solid electrolyte.

In order to improve initial discharge efficiency and initial discharge capacity of the all-solid-state battery, the additional amount of the solid electrolyte is more preferably 0.1 to 1.0 parts by weight based on 100 parts by weight of the target amount of the solid electrolyte.

On the other hand, the solid electrolyte uses lithium salt as a means for providing lithium ions. For example, the solid electrolyte may use LiFSI or LiPF6 in consideration of initial discharge efficiency and initial discharge capacity of the solid electrolyte.

A method of manufacturing an all-solid-state battery according to an embodiment of the present invention will now be described.

First, a cathode active material, an anode active material, and a solid electrolyte are prepared. Here, the cathode active material and the anode active material may use a variety of cathode active materials and anode active materials widely used in all-solid-state batteries.

However, the solid electrolyte may use lithium salt as a means for providing lithium ions. For example, the solid electrolyte may use LiFSI or LiPF6.

When the cathode active material, the anode active material, and the solid electrolyte are prepared, the amounts of the cathode active material, the anode active material, and the solid electrolyte are determined according to the capacity of the all-solid-state battery. In particular, a target amount of the solid electrolyte is set corresponding to the amounts of the cathode active material and the anode active material.

When the target amount of the solid electrolyte is set, an additional amount of the solid electrolyte further added to supplement lithium ions that are consumed in the initial side reaction is set. Here, the additional amount of the solid electrolyte is set to equal to or less than 1.5 parts by weight (excluding 0 parts by weight) based on 100 parts by weight of the target amount of the solid electrolyte. The additional amount of the solid electrolyte is preferably set to 0.1 to 1.0 parts by weight based on 100 parts by weight of the target amount of the solid electrolyte.

When the target amount and the additional amount of the solid electrolyte are set, an actual amount of the solid electrolyte is determined by adding the additional amount to the target amount.

Then, a battery is formed by applying the actual amount of the solid electrolyte.

Next, the present invention will be described with reference to Comparative Examples and Examples.

The initial efficiency and the initial capacity were measured while changing the additional amount of the solid electrolyte as shown in Table 1 below, and the results are also shown in Table 1. Here, LiFSI was used as the solid electrolyte.

TABLE 1

| | Additional | | |
|---|---|---|---|
| | Amount(parts | Initial | Initial |
| Classification | by weight) | Efficiency(%) | Capacity(mAh/g) |
| Comparative | 0 | 72 | 121 |
| Example 1 | | | |
| Example 1 | 0.1 | 76 | 135 |
| Example 2 | 0.5 | 85 | 151 |
| Example 3 | 1.0 | 77 | 132 |
| Example 4 | 1.5 | 75 | 129 |
| Comparative | 2.0 | 72 | 124 |
| Example 2 | | | |
| Comparative | 2.5 | 71 | 123 |
| Example 3 | | | |

As can be seen from Table 1, it was confirmed that the initial efficiency and the initial capacity were improved in Examples 1 to 4 in which the additional amount of the solid electrolyte was further added as compared with Comparative Example 1 in which the target amount of the solid electrolyte was added. However, Example 3 and Example 4 in which the solid electrolyte was further added based on Example 2 show that the initial efficiency and the initial capacity thereof are relatively lower than those of Example 2. In particular, Comparative Examples 2 and 3 in which the additional amount of the solid electrolyte exceeds 1.5 parts by weight, which is the maximum value proposed in the present invention, show that the initial efficiency and the initial capacity thereof are lower than those of Examples 3 and 4.

Thus, it was confirmed that the additional amount of the solid electrolyte is preferably further added by the appropriate amount proposed in the present invention.

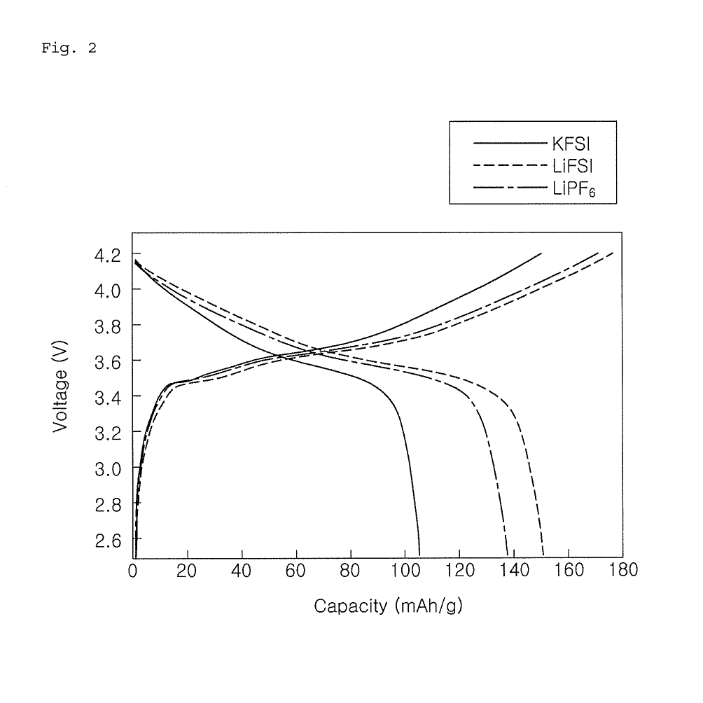

Next, the initial efficiency and the initial capacity were measured by changing the type of lithium salt as shown in Table 2 to confirm the change of the initial efficiency and the initial capacity according to the type of lithium salt used as the solid electrolyte, and the results are also shown in Table 2 and FIG. 2. Here, the additional amount of the solid electrolyte was fixed to 0.5 parts by weight and 1.5 parts by weight.

TABLE 2

| | Initial | Initial |
|---|---|---|
| Solid Electrolyte Type | Efficiency(%) | Capacity(mAh/g) |
| LiFSI | 85 | 151 |
| LiPF6 | 81 | 138 |
| KFSI | 70 | 105 |

As can be seen from Table 2 and FIG. 2, it was confirmed that the initial efficiency and the initial capacity were improved when LiFSI or LiPF6 was used as compared with the case of using KFSI as the lithium salt used as the solid electrolyte.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An all-solid-state battery, comprising
a cathode active material;
an anode active material; and
a solid electrolyte,
wherein the amount of the solid electrolyte is determined by the sum of a target amount of the solid electrolyte, the target amount being set corresponding to the amounts of the cathode active material and the anode active material, and an additional amount of the solid electrolyte,
wherein the additional amount of the solid electrolyte is equal to or less than 1.5 parts by weight (excluding 0 parts by weight) based on 100 parts by weight of the target amount of the solid electrolyte.

2. The all-solid-state battery of claim 1, wherein the solid electrolyte is lithium salt.

3. The all-solid-state battery of claim 2, wherein the solid electrolyte is LiFSI or LiPF6.

4. The all-solid-state battery of claim 1, wherein the additional amount of the solid electrolyte is 0.1 to 1.0 parts by weight based on 100 parts by weight of the target amount of the solid electrolyte.

5. A method of manufacturing an all-solid-state battery, wherein the all-solid-state battery includes a cathode active material, an anode active material, and a solid electrolyte, the method comprising:
preparing a cathode active material, an anode active material, and a solid electrolyte;
setting a target amount of the solid electrolyte corresponding to the amounts of the cathode active material and the anode active material;
determining an actual amount of the solid electrolyte by adding an additional amount of the solid electrolyte set to equal to or less than 1.5 parts by weight (excluding 0 parts by weight) based on 100 parts by weight of the target amount of the solid electrolyte to the target amount of the solid electrolyte; and
forming a battery by applying the actual amount of the solid electrolyte.

6. The method of claim 5, wherein the solid electrolyte is lithium salt.

7. The method of claim 6, wherein the solid electrolyte is LiFSI or LiPF6.

8. The method of claim 5, wherein the additional amount of the solid electrolyte is 0.1 to 1.0 parts by weight based on 100 parts by weight of the target amount of the solid electrolyte.
